(19) United States
(12) Patent Application Publication
(10) Pub. No.: US 2018/0050824 A1
(43) Pub. Date: Feb. 22, 2018

(54) ASSEMBLY OF COMPONENTS WITH DATUM FEATURES

(71) Applicant: BOMBARDIER INC., Dorval (CA)

(72) Inventors: Laurent REGNAULT, Montréal (CA); Alexandros ILIOPOULOS, Montreal (CA); Sebastien SIROIS, Mirabel (CA)

(21) Appl. No.: 15/557,705

(22) PCT Filed: Mar. 10, 2016
(86) PCT No.: PCT/IB2016/051380

§ 371 Date: Sep. 12, 2017

Related U.S. Application Data
(60) Provisional application No. 62/132,091, filed on Mar. 12, 2015.

(51) Int. Cl. B64F 5/10; G05B 19/418

(52) U.S. Cl. CPC B64F 5/10; G05B 19/41805

(57) ABSTRACT

There are described herein methods and systems for manufacturing and/or assembling components having datum features thereon used to derive datum reference frames. The datum reference frames provided on the components may serve as both manufacturing and assembly datum reference frames.

### CROSS-REFERENCE TO RELATED APPLICATIONS

This application claims priority under 35 U.S.C. 119(e) of U.S. Provisional Patent Application No. 62/132,091, filed on Mar. 12, 2015, and entitled “Assembly Of Components With Datum Features”, the contents of which are hereby incorporated by reference.

### TECHNICAL FIELD

The present invention relates to the field of component assembly and particularly, to assembling components that are manufactured and assembled using datum features.

### BACKGROUND OF THE ART

There are certain challenges associated with putting together components for a large assembly, such as an aircraft. Components that have curved and/or complex shapes and need to fit into other components with tight tolerances are particularly difficult and time-consuming to assemble. If the two components are not perfectly aligned, there may be dashes that disrupt the process and cause damage to one or both of the components being assembled. In addition, misalignment can result in undesirable impact to the performance of the component.

Increased time spent assembling components leads to increased costs for the overall product. There is a need to reduce the time taken to assemble such components together, and to prevent disruptions of the assembly process caused by dashes between the components during assembly.

### SUMMARY

There are described herein methods and systems for manufacturing and/or assembling components having datum features thereon used to derive datum reference frames. The datum reference frames provided on the components may serve as both manufacturing and assembly datum reference frames.

In accordance with a first broad aspect, there is provided a method for assembling a wing and a wing box of an aircraft. The method comprises providing an aircraft wing component having at least one wing attachment surface, the wing attachment surface having tolerances defined with respect to at least one wing datum feature located in proximity to the wing attachment surface; providing an aircraft wing box component having at least one wing box attachment surface, the wing box attachment surface having tolerances defined with respect to at least one wing box datum feature located in proximity to the wing box attachment surface; and assembling the wing component and the wing box component together by superposing the at least one wing datum feature with the at least one wing box datum feature so as to place the at least one wing attachment surface in position to be fastened to the at least one wing box attachment surface.

In some embodiments, a wing datum reference frame is defined by at least three wing datum features and a wing box datum reference frame is defined by at least three wing box datum features, and assembling the wing component and the wing box component comprises superposing the wing datum reference frame and the wing box datum reference frame. The at least three wing datum features and the at least three wing box datum features may be provided on the wing attachment surface and the wing box attachment surface, respectively.

In some embodiments, when the at least one wing datum feature and the at least one wing box datum feature are superposed, at least a portion of the wing attachment surface is in contact with at least a portion of the wing box attachment surface.

The method may further comprise referencing the wing component and the wing box component in an assembly reference system using an indoor positioning system. Referencing the wing component and the wing box component may comprise placing at least three targets on each of the wing component and the wing box component, and detecting a position and an orientation in the assembly reference system of each of the wing component and the wing box component using the at least three targets.

The at least one wing datum feature and the at least one wing box datum feature may be physically identifiable on a respective one of the wing component and the wing box component. For example, the at least one wing datum feature and the at least one wing box datum feature are holes.

In some embodiments, assembling the wing component and the wing box component comprises placing the wing component and the wing box component in a pre-join position, the at least one wing datum feature positioned with respect to the at least one wing box datum feature; from the pre-join position, moving the wing component and the wing box component into a pre-final position with a gap between the wing attachment surface and the wing box attachment surface; and from the pre-final position, moving the wing component and the wing box component into a final position by contacting the wing attachment surface and the wing box attachment surface. Placing the wing component and the wing box component in a pre-join position may comprise iteratively displacing at least one of the wing component and the wing box component to reach the pre-join position. Moving the wing component and the wing box component into a pre-final position may comprise applying a sequence of predefined moves to at least one of the wing component and the wing box component to reach the pre-final position. Applying the sequence of predefined moves may comprise applying three vector moves to reach the pre-final position. Placing the wing component and the wing box component in a pre-join position may comprise aligning the at least one wing datum feature and the at least one wing box datum feature with an offset for subsequent displacements.

In some embodiments, providing the wing component and providing the wing box component comprises manufacturing the wing component and manufacturing the wing box component, respectively. Manufacturing the wing component and manufacturing the wing box component may comprise designing the wing component and the wing box component in accordance with product features and performance requirements; providing the at least one wing datum feature on the wing component and the at least one wing box datum feature on the wing box component; setting manufacturing tolerances for the wing attachment surface with respect to the at least one wing datum feature and setting manufacturing tolerances for the wing box attachment surface with respect to the at least one wing box datum feature; and manufacturing the wing component and the wing box component in accordance with the manufacturing tolerances as referenced from the at least one wing datum feature and the at least one wing box datum feature, respectively.

In accordance with another broad aspect there is provided an aircraft assembly comprising an aircraft wing component having at least one wing attachment surface, the at least one wing attachment surface having tolerances defined with respect to at least one wing datum feature located in proximity to the at least one wing attachment surface; and an aircraft wing box component having at least one wing box attachment surface, the at least one wing box attachment surface having tolerances defined with respect to at least one wing box datum feature located in proximity to the at least one wing box attachment surface, the at least one wing attachment surface and the at least one wing box attachment surface spaced by a gap of between about 0.150 inches and zero inches in a final assembly position prior to being fastened.

In some embodiments, the wing component comprises a wing datum reference frame defined by at least three wing datum features and the wing box component comprises a wing box datum reference frame defined by at least three wing box datum features, and wherein the wing datum reference frame is superposed with the wing box datum reference frame. The at least three wing datum features and the at least three wing box datum features may be provided on the wing attachment surface and the wing box attachment surface, respectively.

In some embodiments, at least a portion of the wing attachment surface is in contact with at least a portion of the wing box attachment surface. The at least one wing datum feature and the at least one wing box datum feature may be physically identifiable on a respective one of the wing component and the wing box component. For example, the at least one wing datum feature and the at least one wing box datum feature may be holes.

In some embodiments, the gap between the at least one wing attachment surface and the at least one wing box attachment surface is filled with a filler material prior to being fastened. When fastened together, the gap between the at least one wing attachment surface and the at least one wing box attachment surface may be closed with negligible deformation of the wing attachment surface and the wing box attachment surface. In some embodiments, the gap is between about 0.100 inches and zero inches.

In accordance with another broad aspect, there is provided a system for assembling a wing component and a wing box component of an aircraft. The system comprises a memory; a processor coupled to the memory; and at least one application stored in the memory and having program code executable by the processor. The code may be executable for determining a relative position of a wing component and a wing box component in an assembly reference frame, the wing component having at least one wing attachment surface, the wing attachment surface having tolerances defined with respect to at least one wing datum feature located in proximity to the wing attachment surface, the wing box component having at least one wing box attachment surface, the wing box attachment surface having tolerances defined with respect to at least one wing box datum feature located in proximity to the wing box attachment surface; and assembling the wing component and the wing box component together by generating command signals for the at least one wing datum feature with the at least one wing box datum feature so as to place the at least one wing attachment surface in position to be fastened to the at least one wing box attachment surface.

In some embodiments, a wing datum reference frame is defined by at least three wing datum features and a wing box datum reference frame is defined by at least three wing box datum features, and assembling the wing component and the wing box component comprises superposing the wing datum reference frame and the wing box datum reference frame.

Assembling the wing component and the wing box component may comprise generating command signals for placing the wing component and the wing box component in a pre-join position, the at least one wing datum feature positioned with respect to the at least one wing box datum feature; from the pre-join position, moving the wing component and the wing box component into a pre-final position with a gap between the wing attachment surface and the wing box attachment surface; and from the pre-final position, moving the wing component and the wing box component into a final position by contacting the wing attachment surface and the wing box attachment surface.

Placing the wing component and the wing box component in a pre-join position may comprise iteratively displacing at least one of the wing component and the wing box component to reach the pre-join position. Moving the wing component and the wing box component into a pre-final position may comprise applying a sequence of predefined moves to at least one of the wing component and the wing box component to reach the pre-final position. Applying the sequence of predefined moves may comprise applying three vector moves to reach the pre-final position. Placing the wing component and the wing box component in a pre-join position may comprise aligning the at least one wing datum feature and the at least one wing box datum feature with an offset for subsequent displacements.

The system may further comprise an indoor positioning system operatively connected to the processor for determining the relative position of the wing component and the wing box component. The system may also further comprise an assembly tool on which at least one of the wing component and the wing box component is mounted, the assembly tool operatively connected to the processor for receiving the command signals for assembling the wing component and the wing box component together.

### BRIEF DESCRIPTION OF THE DRAWINGS

Further features and advantages of the present invention will become apparent from the following detailed description, taken in combination with the appended drawings, in which:

FIG. 1a is an exemplary datum reference frame;

FIG. 1b is an exemplary wing component;

FIG. 1c is an exemplary wing box component;

FIG. 1d illustrates schematically an alignment of datum features on a wing box component and a wing component, in accordance with an embodiment;

FIG. 2 is a flowchart of an exemplary assembly method;

FIG. 3 is a flowchart of an exemplary manufacturing method;

Fig. illustrates schematically an indoor positioning system for positioning and orienting components in an assembly reference frame;

FIG. 5 is a flowchart of an exemplary embodiment for assembling two components together using multiple displacements;

FIG. 6a illustrates two components in a pre-join position, in accordance with an embodiment;

FIG. 6b illustrates two components in a pre-final position, in accordance with an embodiment;

FIG. 6c illustrates two components in a final position, in accordance with an embodiment;

FIG. 7 is a flowchart of an exemplary embodiment for placing the components in a pre-join position;

FIG. 8a illustrates two components after a first vector displacement, in accordance with an embodiment;

FIG. 8b illustrates two components after a second vector displacement, in accordance with an embodiment;

FIG. 8c illustrates two components after a third vector displacement, in accordance with an embodiment;

FIG. 9 illustrates an exemplary assembly system;

FIG. 10 is a block diagram of an exemplary assembly controller;

FIG. 11 is a block diagram of an exemplary application running on the assembly controller; and

FIG. 12 is an exemplary aircraft assembly.

It will be noted that throughout the appended drawings, like features are identified by like reference numerals.

### DETAILED DESCRIPTION

Referring to the figures, two components are provided for assembling together into an assembly. The components are illustratively a wing and a wing box, but may be other aircraft components, such as but not limited to, a fuselage, a pylon, a winglet, a spoiler, a rudder, and a flap. The components may be for other types of vehicles, such as ships, trains, and automobiles, or for other applications, such as power plants, wind turbines, and damns. The components may be composites, made from two or more constituent materials, single material components, or multi-layer non-composite components. The components may be made from various materials, such as but not limited to metals, polymers, textiles, resins, and fiber glass. In some embodiments, the components have at least one surface that is curved, for example the attachment surface, i.e. the surface that contacts the other component when assembled may have a slight or pronounced curvature.

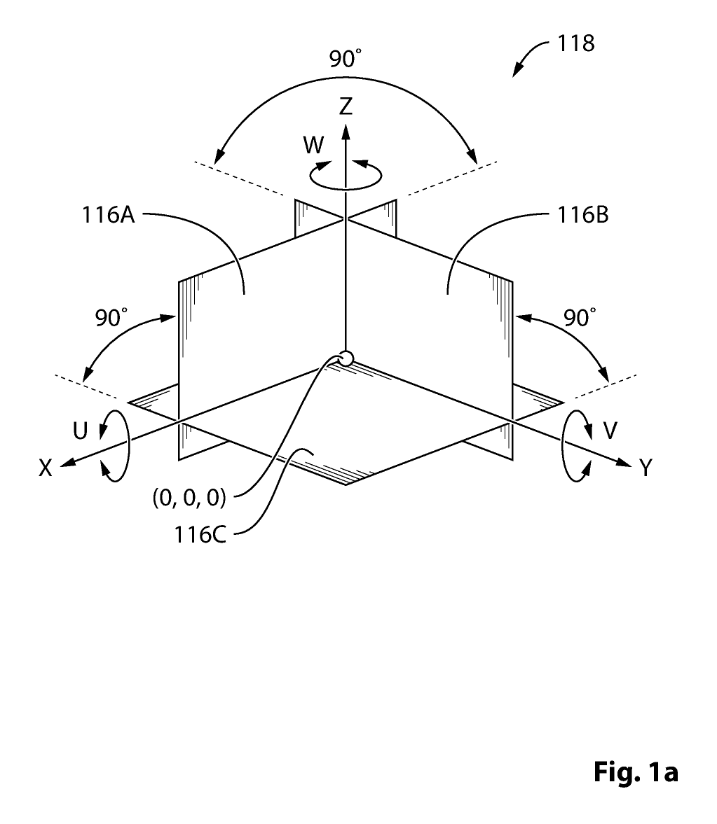

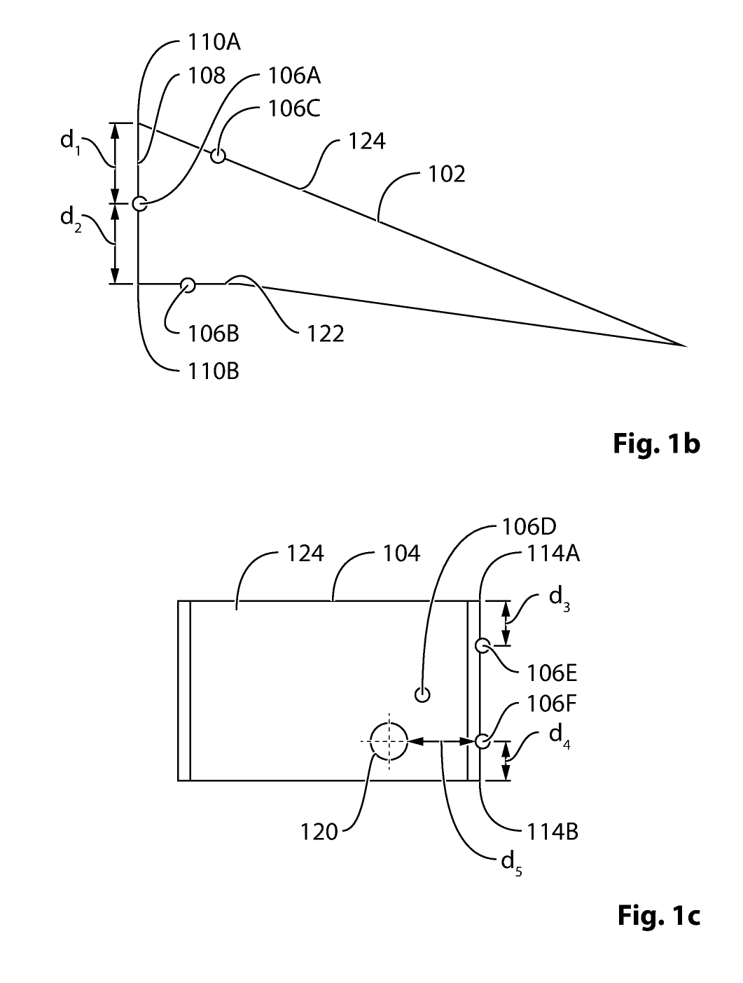

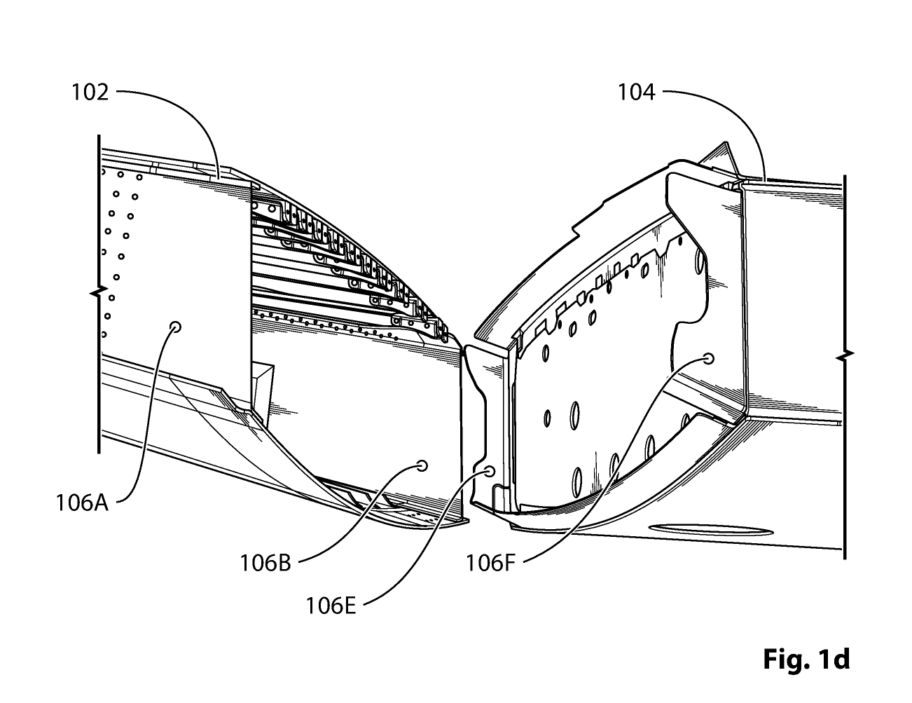

Each component has at least three datum features provided thereon. The datum features are used to create a datum reference frame, and manufacturing tolerances for the attachment surface are generally referenced with respect to the datum reference frame. A datum is a theoretically exact point, line, or plane. FIG. 1a illustrates an exemplary datum reference frame 118, defined by three mutually perpendicular intersecting datum planes 116a, 116b, 116c. The reference frame 118 defines six degrees of freedom for a component, three translational and three rotational. The three translational degrees of freedom are x, y, and z, while the three rotational degrees of freedom are u, v, and w. The datum reference frame is obtained using the at least three datum features provided on a component.

In FIG. 1b, three datum features 106a, 106b, 106c (in this case datum points) are used on a wing component 102 to obtain the datum reference frame 118. A first datum point 106a is provided on an attachment surface 108, a second datum point 106b is provided on a lower wing surface 122 and a third datum point 106c is provided on an upper wing surface 124. Tolerances for features of the attachment surface 108, such as edges 110a, 110b, are set with respect to the datum reference frame 118 and more particularly, with respect to the origin (0, 0, 0) of the datum reference frame 118. Datum point 106a may correspond to the origin (0, 0, 0) of the reference frame, and edge 110a is set to be a distance d₁±a units from datum point 106a. Edge 110b is set to be a distance d₂±b units from datum point 106a. Alternatively, datum points 106b or 106c may correspond to the origin (0, 0, 0) of the datum reference frame 118 and the tolerances for edges 110a, 110b are set in reference to 106b or 106c. Also alternatively, datum points 106a, 106b, and 106c are used to obtain the datum reference frame 118 and another point on the component 102 is set to correspond to the origin (0, 0, 0) for the purpose of setting the tolerances of the features of the attachment surface 108 within the datum reference frame 118.

FIG. 1c illustrates another three datum points 106d, 106e, 106f provided on a wing box component 104. In this example, datum point 106d is on a top surface 124, while datum points 106e and 106f are on attachment surface 112. Edge 114a is set to be a distance d₃±c units from datum point 106e. Edge 114b is set to be a distance d₄±e units from datum point 106f. The tolerance margins, i.e. a units, b units, c units, e units, may be the same or different.

In some embodiments, datum points 106a, 106b, 106c, 106d, 106e, 106f are physically identifiable on the components 102, 104. For example, datum 106a may be a hole, a notch, or a protruding member on the wing component 102. The datum points 106a, 106b, 106c, 106d, 106e, 106f may be built into the components 102, 104 as an additional feature to serve only as a reference point for manufacturing tolerances, or they may be existing features of the components 102, 104 that have a dual purpose, one of which is to serve as a reference point for manufacturing tolerances. Alternatively, the datum points 106a, 106b, 106c may be virtual datum points with coordinates that are defined with respect to a physical feature of the component 102, 104. For example, datum 106f on the wing box component 104 may be set as being a distance d₅ from a hole 120 on top surface 124.

The datum points may be provided on an attachment surface of a component or elsewhere. For example, the datum points may be adjacent or near the attachment surface without being directly thereon. In some embodiments, it may be useful to have the datum points in the vicinity of the attachment surface for alignment purposes during assembly, as will be explained in more detail below. Surfaces of components that are meant to be in contact when assembled may have a same or different number of datum points. In some embodiments, attaching surfaces have datum points that are positioned to be superposed when the two components are assembled together. This is exemplified in FIG. 1d, whereby the wing component 102 has its datum points 106a, 106b positioned to coincide with the datum points 106e, 106f of the wing box component 104.

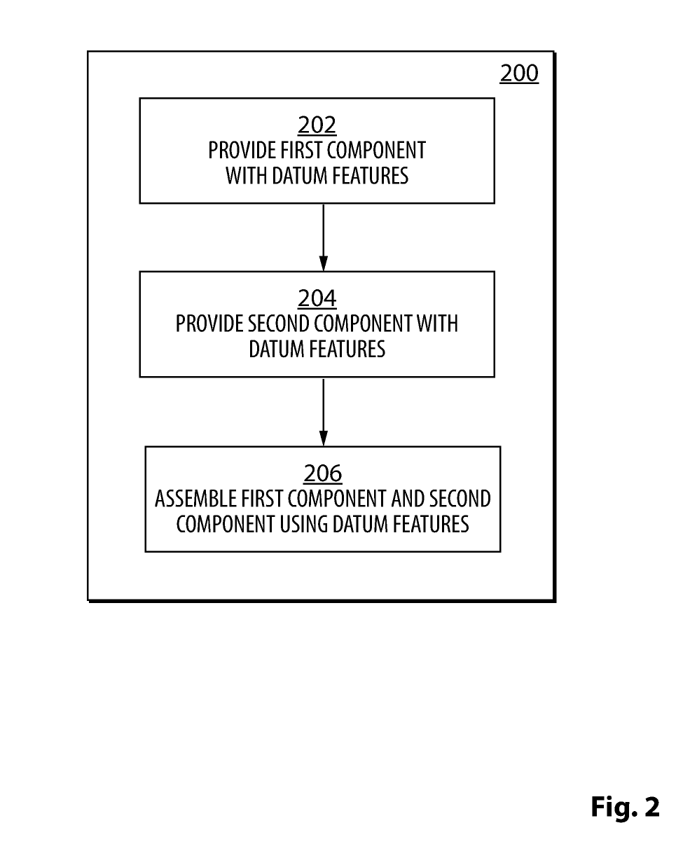

FIG. 2 is an exemplary method 200 for assembling a first component and a second component into an assembly. As per step 202, a first component 102, such as a wing, for example, with datum features thereon, as illustratively presented in FIG. 1b, is provided. The first component 102 has tolerances for at least one first attachment surface 108 referenced with respect to a first datum reference frame on the first component 102. While the datum features may be positioned anywhere on the first component 102, in practice, they may be positioned in relative proximity to the first attachment surface 108 to allow for better accuracy of the attachment surface 108 tolerances. “In proximity to” the attachment surface should be understood to mean on or adjacent thereto.

In the case of an aircraft wing, as shown in FIG. 1d, having the tolerances for at least the first attachment surface 108 be referenced with respect to a datum reference frame in proximity to the first attachment surface 108 allows tighter control over the positioning of the walls and edges (110a, 110b) that form the first attachment surface 108. Previously, the tolerances for an aircraft wing were simply related to a width dimension and a height dimension, for example, without having those tolerance dimensions necessarily resulting in consistency with the wall and edge positions that make up the wing attachment surface. Therefore, by having tolerances for the first attachment surface 108 referenced to a datum feature in proximity to the first attachment surface 108, this provides improved predictability that all points along the first attachment surface 108 will properly align with a corresponding attachment surface of a wing box.

Referring back to FIG. 2, as per step 204, a second component 104, such as a wing box, for example, with datum features, as illustratively presented in FIG. 1c, is provided. The second component 104 has tolerances for at least one second attachment surface 112 referenced with respect to a datum reference frame derived from the datum features on the second component 104.

In the same manner as described above, in the case of an aircraft wing box, as shown in FIG. 1c, having the tolerances for at least the second attachment surface 112 be referenced with respect to a datum reference frame in proximity to the wing box allows tighter control over the positioning of the walls and edges (114a, 114b) that form the second attachment surface 112. This provides improved predictability that all points along the second attachment surface 112 will properly mate with the corresponding first attachment surface 108 of the wing.

As per step 206, the first component 102 and the second component 104 are assembled together by positioning the datum features on the first attachment surface 108 of the first component 102 with respect to the datum features on the second attachment surface 112 of the second component 104, and contacting the first attachment surface 108 with the second attachment surface 112.

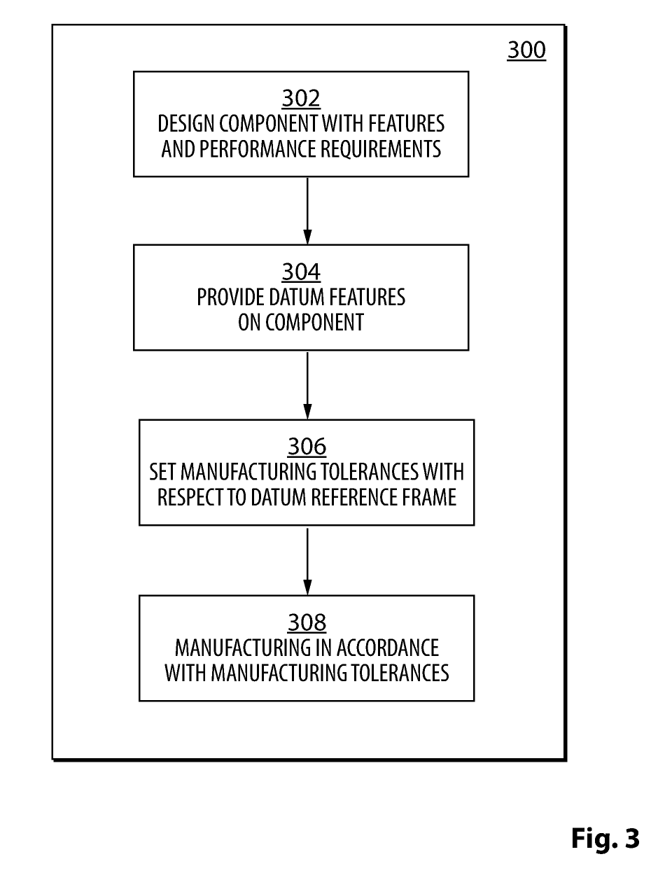

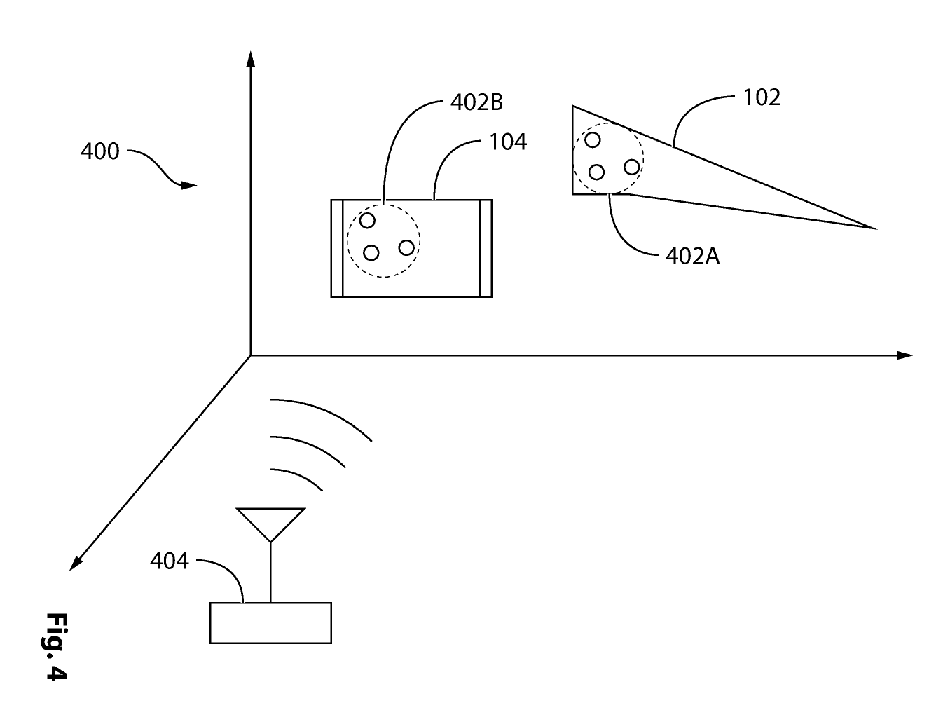

In some embodiments, steps 202 and/or 204 of providing the first and second components 102, 104, respectively, comprise manufacturing the first and/or second component 102, 104. FIG. 3 is a flowchart of an exemplary method 300 for manufacturing a component to be used in the assembly method 200. As per step 302, the component is designed in accordance with product features and performance requirements. In other words, the component is designed to meet any required specifications in terms of features, functionality, and/or performance for its intended purpose. As per step 304, at least three datum features are provided on the component either physically or virtually, and a datum reference frame is derived therefrom. The datum reference frame will act as a reference marker for tolerance requirements of any features of the component provided on or near the attachment surface of the component, as per step 306. Examples of such features are surface dimension(s), edge position, and surface curvature. Any point on the attachment surface may have its position and orientation referenced with respect to the datum reference frame on the component. As per step 308, the component is manufactured in accordance with the tolerances as referenced from the datum reference frame.

In some embodiments, the components are designed and manufactured with spacing or gaps used for assembly of the components. For example, it may be desirable to ensure a sufficient spacing or gap between two components as they are being assembled, before full contact is made between respective attachment surfaces, or even after final assembly. This may be particularly useful for components having complex shapes that have high risks of dashing during the assembly process. The spacing or gaps are sized so as to ensure that performance of the assembly is not compromised while facilitating the assembly process and lowering the risks of clashing.

In some embodiments, the datum feature is provided on the component as a physically identifiable feature as the component is manufactured. For example, the datum feature may be a hole, a notch, or a protruding member of the component. In some embodiments, the datum feature is provided on the attachment surface or adjacent thereto. If there are more than one attachment surface of a given component, one or more datum features may be provided for each attachment surface. Alternatively, the features of each attachment surface may be toleranced with reference to a same set of datum features.

Applying the manufacturing method 300 to the assembly method 200, a wing component and a wing box component may be designed in accordance with product features and performance requirements, as per step 302. At least one first datum reference frame may be provided on the wing component and at least one second datum reference frame may be provided on the wing box component, as per step 304. The manufacturing tolerances for at least one attachment surface of the wing component are set with respect to the at least one first datum reference frame, as per step 306. The manufacturing tolerances for at least one attachment surface of the wing box component are set with respect to the at least one second datum reference frame, also per step 306. The wing component and the wing box component are manufactured in accordance with the manufacturing tolerances as referenced from the at least one first datum reference frame and the at least one second datum reference frame, respectively, as per step 308.

In some embodiments, the assembly method 200 further comprises referencing the first component and the second component together using an indoor positioning system (IPS), such as an indoor Global Positioning System (IGPS) or a laser tracker system. This is illustratively presented in FIG. 4, whereby components 102, 104 are referenced together in an assembly reference frame 400. A first set of targets 402a are placed on the first component 102. A second set of targets 402b are placed on the second component 104. Each set 402a, 402b comprises at least three targets to provide at least three independent measurements using, for example, trilateration or triangulation, in order to find a location of each component 102, 104 within the assembly reference frame 400. At least one base unit 404 communicates wirelessly with the targets 402a, 402b, in order to determine the position of the components 102, 104.

In some embodiments, the targets are passive and simply reflect a signal emitted by the base unit 404. For example, retroreflective optical targets may be used with a laser tracker, or passive RFID tags may be used with a reader. The base unit 404 captures the reflected signal and uses any one of various methods, such as distance measurements, magnetic position, and dead reckoning, to determine position. Alternatively, the targets may be active targets that themselves emit a signal and the emitted signal is captured by the base unit 404. Position determination may be performed using angle of arrival (AoA), time of arrival (ToA), or received signal strength indication (RSSI), for example. Identification data may be provided in the emitted signal such that location is determined based on the ID of the target from which the signal was received. The targets 402a, 402b may be provided at known positions on the components 102, 104, in order to situate the components in the assembly reference frame 400. The assembly reference frame 400 may be the room in which the components 102, 104 sit. The signal emitted by the base unit 404 and/or by the targets 402a, 402b may be, for example, radio frequency, ultrawide band, infrared, visible light, or ultrasound.

Communication between the base unit 404 and the targets 402a, 402b, may be Wi-Fi, Bluetooth, Zigbee, or other wireless technologies. One or more additional targets may be used for additional precision. A plurality of base units 404 may be provided, working together or separately to determine the location of each component 102, 104. In some embodiments, the base unit 404 comprises one or more emitter of infrared rays that scan the room, and the targets 402a, 402b receive the emitted infrared rays. Using a known position of the emitter(s) and a time of receipt of the infrared rays, the targets 402a, 402b may themselves determine their position with respect to the emitter(s). Position and orientation of each component 102, 104 may be determined using the indoor positioning system.

In some embodiments, assembling the first component and the second component comprises applying multiple displacements to at least one of the first component and the second component. These displacements may be applied automatically, manually, or a combination thereof. For example, one or both components 102, 104 may be mounted to an actuation device capable of raising, lowering, and moving a component in multiple directions.

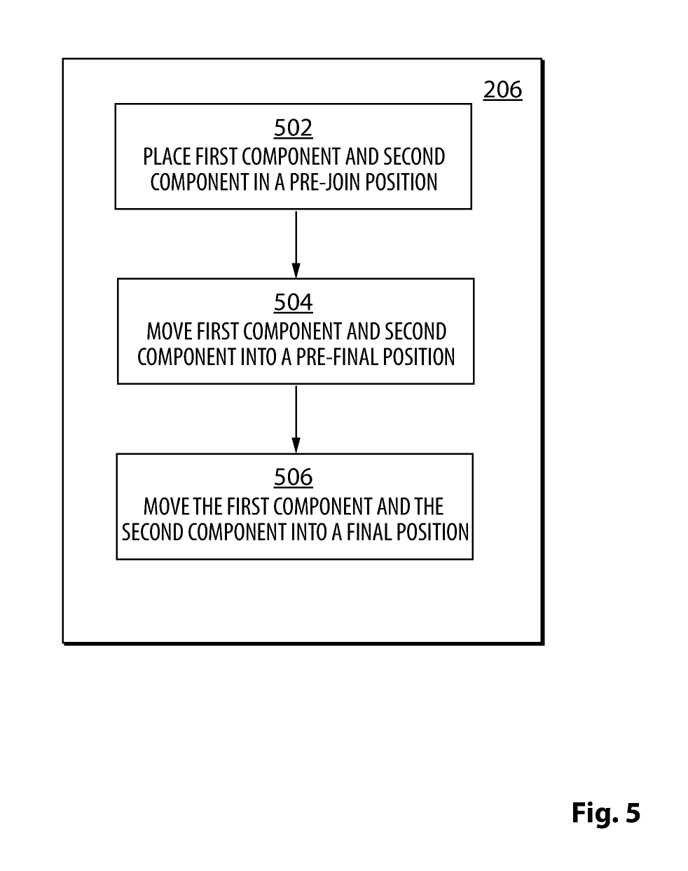

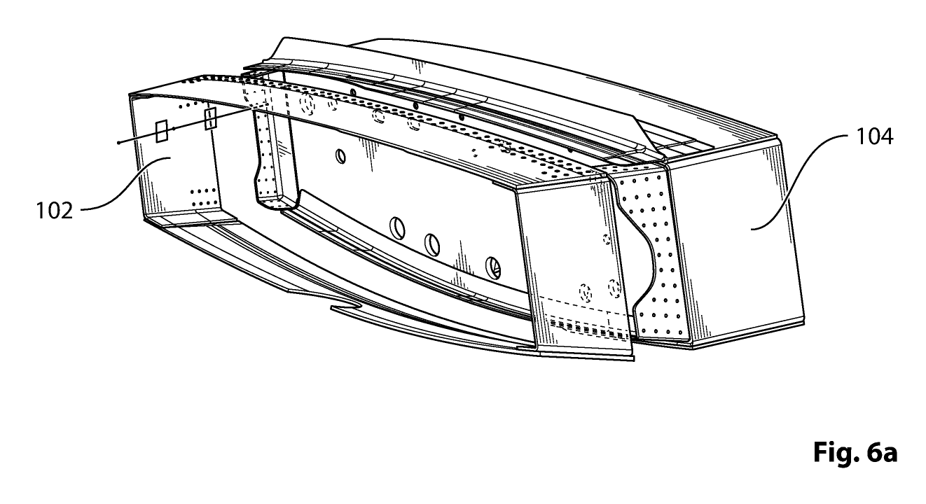

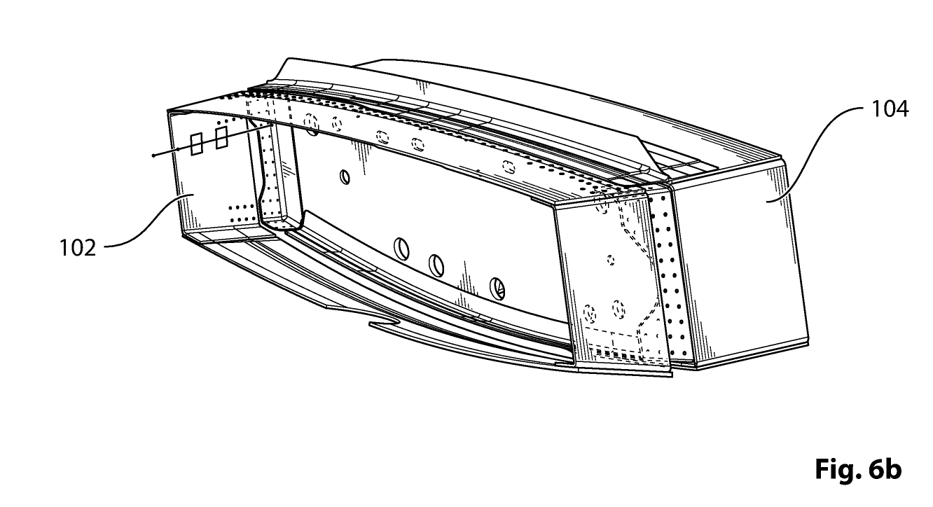

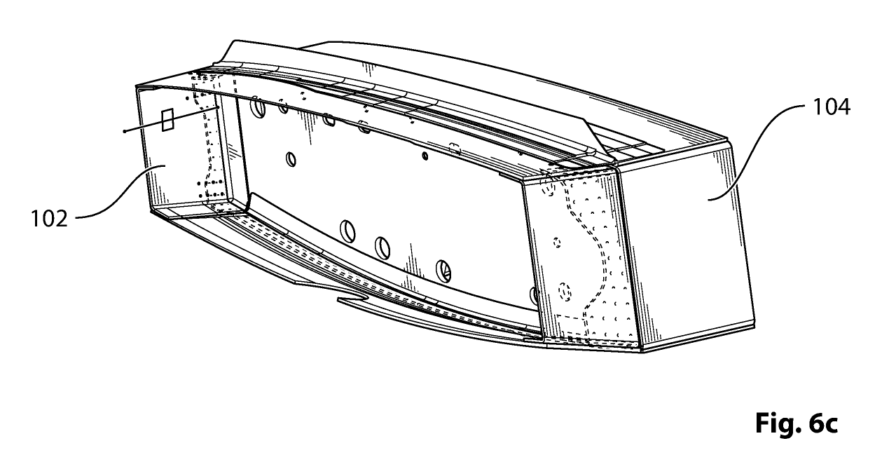

FIG. 5 is a flowchart of an exemplary method for assembling the components, as per step 206 of the assembly method 200, based on multiple displacements of the components. In this example, the components are placed into a pre-join position, in accordance with step 502. In the pre-join position, the first datum reference frame of the first component is positioned with respect to the second datum reference frame of the second component. An example of the pre-join position is shown in FIG. 6a, whereby the wing component 102 is positioned with respect to the wing box component 104, but the two components remain separate. In some embodiments, positioning the first datum reference frame with respect to the second datum reference frame in the pre-join position comprises aligning the datum reference frames. In some embodiments, this alignment is performed with an offset in order to account for additional displacements of the wing component 102 and the wing box component 104 in the subsequent steps of the assembly method 200.

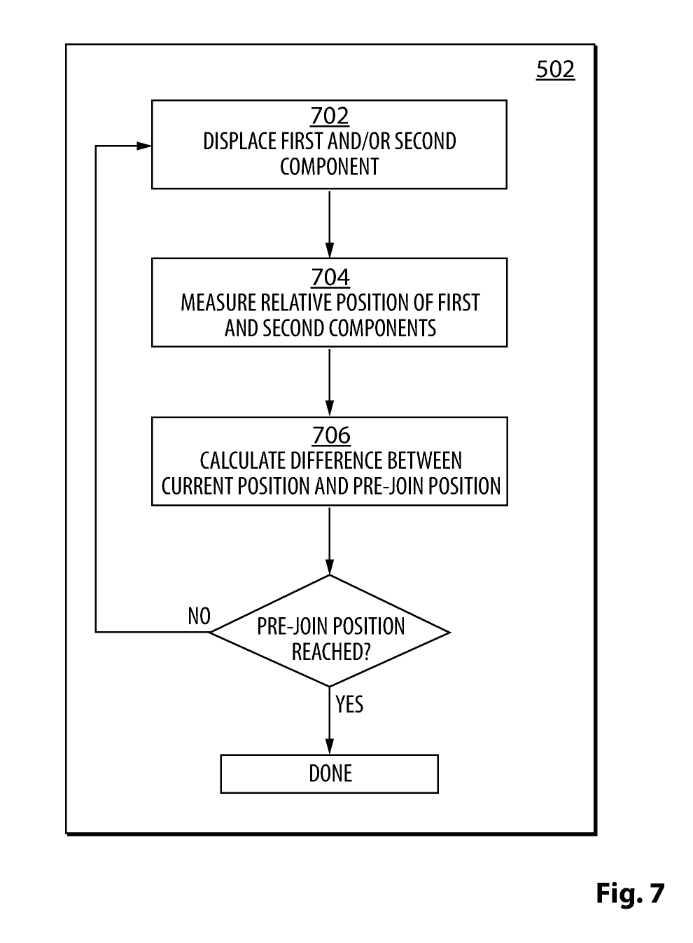

In some embodiments, placing the component in the pre-join position follows one or more previous steps in which the first component and the second component are referenced in the assembly reference frame 400, using for example the indoor positioning system. The position and orientation of the first component is obtained. The position and orientation of the second component is obtained. The relative position of the first component with respect to the second component may then be determined. From this relative position, one or both of the components are displaced to the pre-join position. In some embodiments, placing the first component and the second component in a pre-join position comprises iteratively displacing at least one of the two components to reach the position, as illustrated in FIG. 7. The first and/or second component is displaced, as per step 702, the relative position of the components is measured, as per step 704, and the difference between the current position and the pre-join position is calculated, as per step 706. Depending on whether the pre-join position has been reached or not, the displacement and measurement steps 702, 704 may be repeated.

As indicated above, in the pre-join position, the first and second component are positioned such that the first datum reference frame and the second datum reference frame are positioned into a desired pre-defined position. The pre-defined position may be a position wherein the first datum reference frame and the second datum reference frame are aligned and parallel with respect to one another. Other desired pre-defined positions are also possible.

Referring back to FIG. 5, once the pre-join position has been reached, the first component and second component are moved into a pre-final position, as per step 504. The pre-final position is a position whereby the components are partially fitted together, but a gap remains between at least part of the first attachment surface and at least part of the second attachment surface, as illustratively shown in FIG. 6b.

In some embodiments, displacing the components from the pre-join position to the pre-final position is performed using a set of predetermined displacements, referred to herein as vector displacements. The pre-join position and the pre-final position may be known prior to beginning the assembly method 200. Once the components are referenced within the assembly reference frame 400, it is determined which displacements are to be applied in order to bring the components into the pre-join position. From the pre-join position, the vector displacements are applied to bring the components into the pre-final position. The vector displacements are used to fit together closed shapes or complex shapes, using a path that is not straight. The chosen path may thus follow the shape of each component as two or more components are assembled together.

From the pre-final position, the components are moved into or caused to acquire the final position, as per step 506. The final position is illustratively shown in FIG. 6c, whereby the wing component 102 and the wing box component 104 are fully assembled together. In some embodiments, small gaps remain between the respective attachment surfaces of the components when in the final position. These gaps may be anywhere from 0.150 inches to near zero. Such remaining gaps may be removed by inserting filler material therein, such as shims or other types of spacers, depending on the size of the remaining gap. For example, shims may be used to close a gap of 0.150 inches while a gap of 0.008 inches can be closed without shims. The filler material may be inserted manually or using an automated space filling mechanism. Components may also be fastened together using various fasteners, such as but not limited to screws, dips, pins, anchor bolts, and rivets. In some embodiments, the components are fully assembled together such that they undergo negligible deformation when components are fastened. This is in large part due to the small size of any final remaining gaps between the components and the use of filler material to fill these gaps.

In some embodiments, the components 102, 104 are placed into the pre-join position and the pre-final position using automated displacements, while the displacement into the final position is performed manually. Alternatively, all displacements are automated.

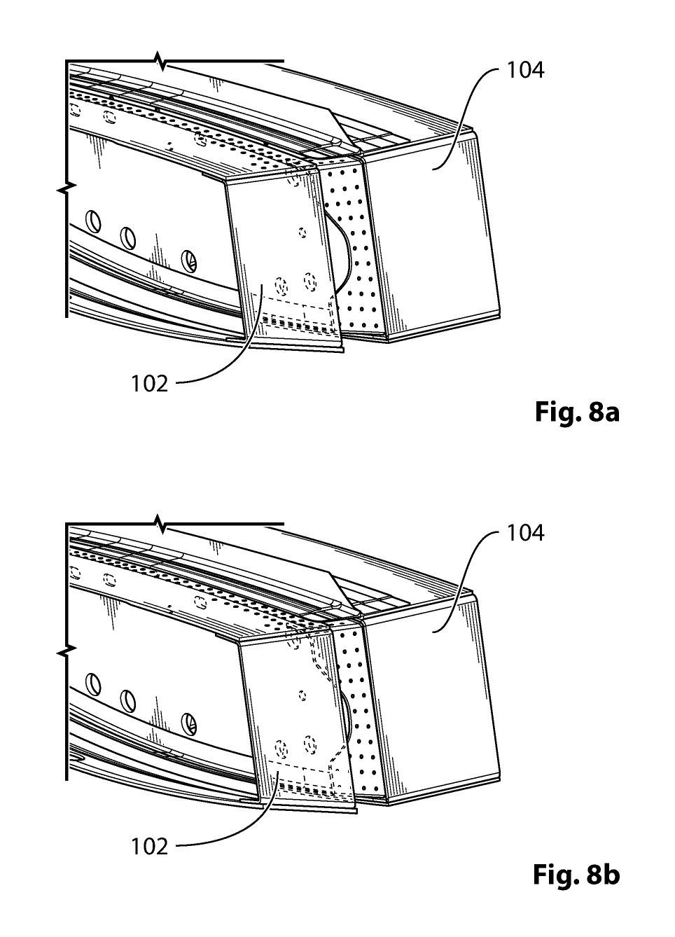

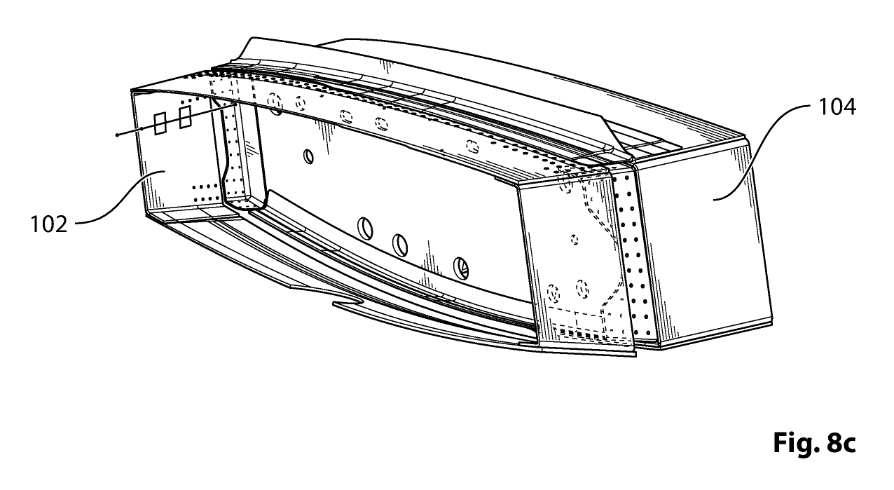

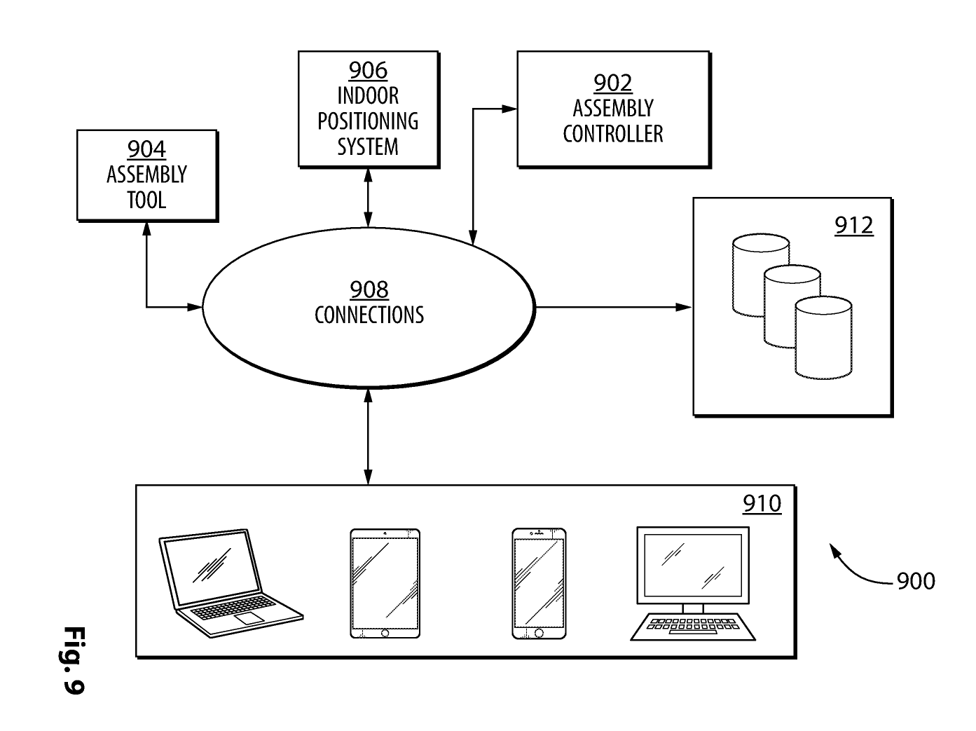

FIGS. 8a, 8b, and 8c are examples of the wing component 102 and the wing box component 104 at various stages of the displacement from the pre-join position to the pre-final position. FIG. 8a shows the wing component 102 engaged into the wing box component 104 such that the two components overlap at least partially. FIG. 8b shows the wing component 102 further engaged into the wing box component 104, while FIG. 8c shows the wing component 102 and the wing box component 104 positioned at the pre-final position.

The number of vector displacements applied to bring the components into the pre-final position may vary. For example, in some embodiments, three vector displacements are applied to one component while the other component remains fixed. Alternatively, vector displacements may be applied to both components. Each vector displacement may have an (x, y, z) coordinate, as per table 1. In some embodiments, rotational vectors (u, v, w) may also be applied to the components.

TABLE 1

| Vector Displacement | Value |
|---|---|
| Vector-1-X | 0.8544 |
| Vector-1-Y | −9.3875 |
| Vector-1-Z | −1.1548 |
| Vector-2-X | 0.2816 |
| Vector-2-Y | −2.4887 |
| Vector-2-Z | −0.2118 |
| Vector-3-X | −0.0077 |
| Vector-3-Y | −0.8499 |
| Vector-3-Z | −0.0060 |

More or less than three vector displacements may be applied. The number of vector displacements may be selected as a function of the shape of the components to be assembled, or the complexity of the assembly procedure. The units for the vector displacements may be inches, centimeters, millimeters, or any other appropriate unit, as a function of the size of the component and the precision available from the actuating device displacing the component.

As indicated above, certain components may have a high risk of dashing during the application of the vector displacements, due to their shape and/or to whether the initial tolerance margins have been respected at the time of manufacture. If a clash occurs, the automatic sequence of vector displacements stops and assembly is completed manually. In order to reduce the risks of clashing, the components may be positioned at the pre-join position with an assembly offset that corresponds to the shape of the components and the displacements that will be applied to bring the components into the pre-final position and/or the final position. An example is provided in table 2, whereby the joint between the wing component and the wing box component are referred to using the rear spar, front spar, tri-form, and cruciform features of the wing box component. In this example, spacing is shown for the different features on the wing box component with respect to mating features on the wing component when the wing box component and the wing component are in the pre-final position. Without the assembly offset, the spacing is based on perfect (or nominal) components, i.e. the parts are manufactured to match exactly the specified dimensions. Clashes during assembly at the rear spar and tri-form features are possible due to the small spacing provided if the components are not manufactured perfectly. To reduce the risk of dashing, an assembly offset is provided at the pre-join position. The assembly offset comprises placing the wing component 0.050″ lower and 0.030″ aft (i.e. towards the tail of the aircraft) with respect to the wing box component. As a result, the spacing at the rear spar, the tri-form, and the cruciform features is increased. The spacing at the front spar feature is decreased but remains sufficiently large to allow for maneuvering during assembly. An assembly offset may be selected as a function of the components to be assembled, in consideration of a shape, size, assembly procedure, or other factor.

TABLE 2

| Feature on wing | Spacing without | Spacing with |
|---|---|---|
| box component | assembly offset | assembly offset |
| Rear spar | 0.015″ | 0.045″ |
| Front spar | 0.075″ | 0.045″ |
| Tri-form | 0.032″ | 0.082″ |
| Cruciform | 0.050″ | 0.100″ |

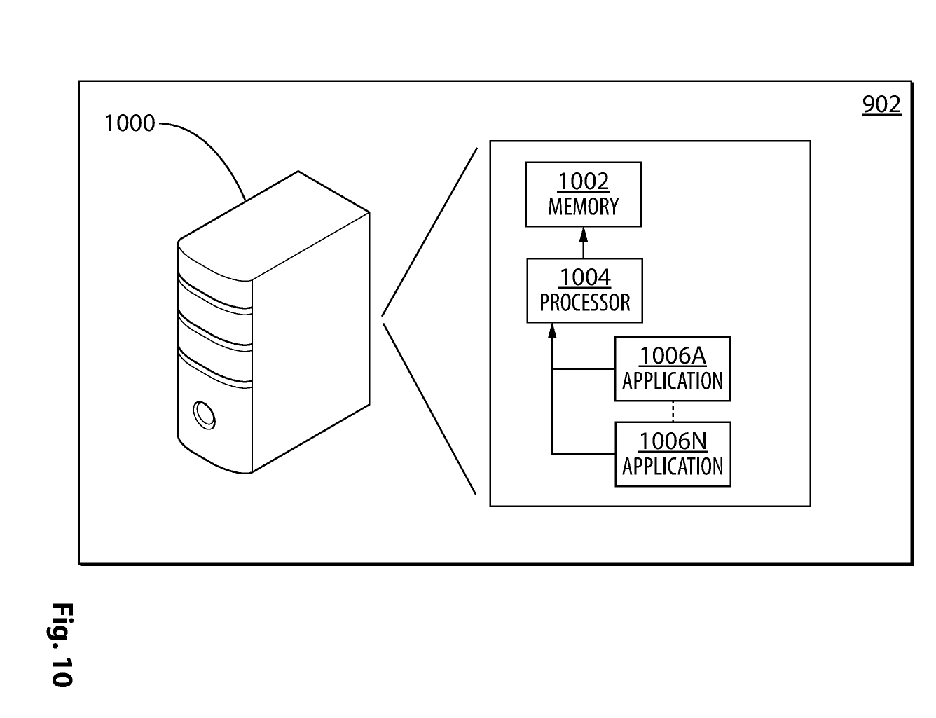

Turning to FIG. 9, there is illustrated an exemplary embodiment of a component assembly system 900. An assembly controller 902 is operatively connected to an assembly tool 904 and an indoor positioning system 906, in order to assemble components as per the methods described above. The assembly tool 904 may comprise one or more actuating devices to which the components may be mounted for assembly. The indoor positioning system 906 may comprise targets and one or more base units, as described above. Although illustrated as being separate and remote from the assembly tool 904 and the indoor positioning system 906, the assembly controller 902 may also be integrated with the assembly tool 904 and/or indoor positioning system 906, either as a downloaded software application, a firmware application, or a combination thereof.

Various types of connections 908 may be provided to allow the assembly controller 902 to communicate with the assembly tool 904 and indoor positioning system 906. For example, the connections 908 may comprise wire-based technology, such as electrical wires or cables, and/or optical fibers. The connections 908 may also be wireless, such as RF, infrared, Wi-Fi, Bluetooth, and others. Connections 908 may therefore comprise a network, such as the Internet, the Public Switch Telephone Network (PSTN), a cellular network, or others known to those skilled in the art. Communication over the network may occur using any known communication protocols that enable devices within a computer network to exchange information. Examples of protocols are as follows: IP (Internet Protocol), UDP (User Datagram Protocol), TCP (Transmission Control Protocol), DHCP (Dynamic Host Configuration Protocol), HTTP (Hypertext Transfer Protocol), FTP (File Transfer Protocol), Telnet (Telnet Remote Protocol), SSH (Secure Shell Remote Protocol).

The assembly controller 902 may be accessible remotely from any one of a plurality of devices 910 over connections 908. The devices 910 may comprise any device, such as a personal computer, a tablet, a smart phone, or the like, which is configured to communicate over the connections 908. In some embodiments, the component reshaping system may itself be provided directly on one of the devices 910, either as a downloaded software application, a firmware application, or a combination thereof.

One or more databases 912 may be integrated directly into the assembly controller 902 or any one of the devices 910, or may be provided separately therefrom (as illustrated). In the case of a remote access to the databases 912, access may occur via connections 908 taking the form of any type of network, as indicated above. The various databases 912 described herein may be provided as collections of data or information organized for rapid search and retrieval by a computer. The databases 912 may be structured to facilitate storage, retrieval, modification, and deletion of data in conjunction with various data-processing operations. The databases 912 may be any organization of data on a data storage medium, such as one or more servers. The databases 912 illustratively have stored therein any one of component dimensions and/or specifications, component datum features, datum reference frames, manufacturing tolerances, target positions, base station positions, assembly reference frames, component positions in assembly reference frames, pre-join positions, pre-final positions, final positions, vector displacements, measured relative positions of components, calculated differences between positions, and assembly offsets.

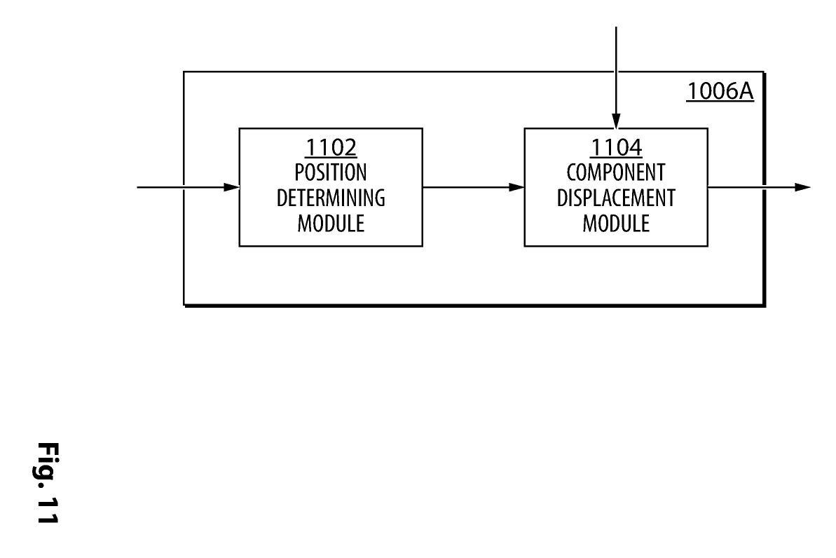

As shown in FIG. 10, the assembly controller 902 illustratively comprises one or more server(s) 1000. For example, a series of servers corresponding to a web server, an application server, and a database server may be used. These servers are all represented by server 1000 in FIG. 10. The server 1000 may be accessed by a user, such as a technician or an assembly line worker, using one of the devices 910, or directly on the assembly controller 902 via a graphical user interface (not shown). The server 1000 may comprise, amongst other things, a plurality of applications 1006a . . . 1006n running on a processor 1004 coupled to a memory 1002. It should be understood that while the applications 1006a . . . 1006n presented herein are illustrated and described as separate entities, they may be combined or separated in a variety of ways.

The memory 1002 accessible by the processor 1004 may receive and store data. The memory 1002 may be a main memory, such as a high speed Random Access Memory (RAM), or an auxiliary storage unit, such as a hard disk, a floppy disk, or a magnetic tape drive. The memory 1002 may be any other type of memory, such as a Read-Only Memory (ROM), or optical storage media such as a videodisc and a compact disc. The processor 1004 may access the memory 1002 to retrieve data. The processor 1004 may be any device that can perform operations on data. Examples are a central processing unit (CPU), a front-end processor, a microprocessor, and a network processor. The applications 1006a . . . 1006n are coupled to the processor 1004 and configured to perform various tasks. An output may be transmitted to the assembly tool 904, the indoor positioning system 906 and/or to the devices 910.

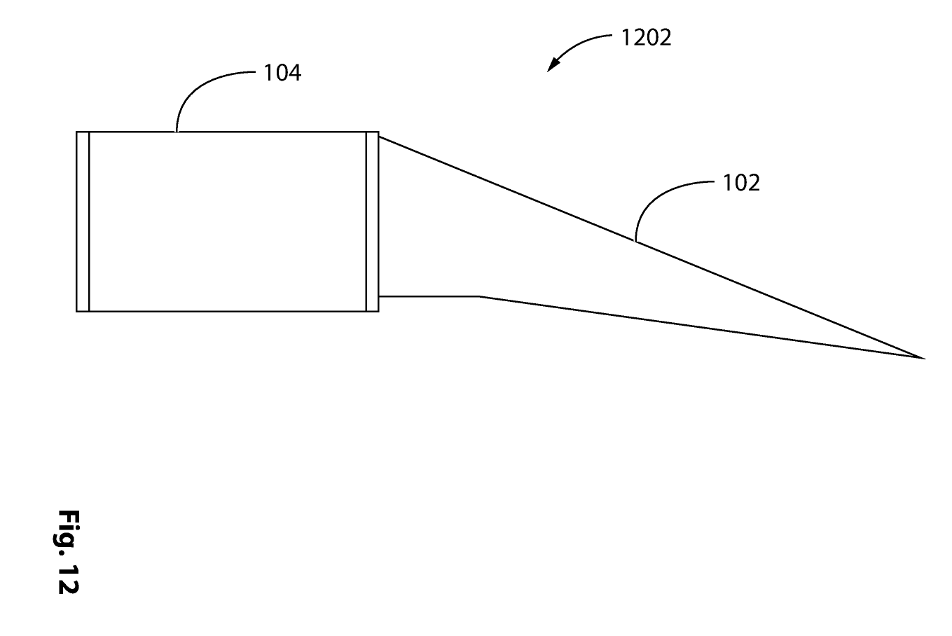

FIG. 11 is an exemplary embodiment of an application 1006a running on the processor 1004. The application 1006a illustratively comprises a position determining module 1102 and a component displacement module 1104. The position determining module 1102 may be configured to determine the position and orientation of each component within the assembly reference frame. In some embodiments, this determination is done using the indoor positioning system 906. The position determining module 1102 may receive as input the readings obtained from the base units 404 and/or targets 402a, 402b, and based on those inputs, determine the relative position of the wing component and wing box component in the assembly reference frame. The relative position of the components may be provided to the component displacement module 1104, which is configured to provide control signals to the assembly tool 904 in order to assemble the components together, as per step 206 of the assembly method described above. The component displacement module 1104 may also receive as inputs various control signals for assembling the components together. For example, additional inputs may comprise pre-join positions, vector displacements, pre-final positions, etc.

In some embodiments, the component displacement module 1104 may be configured to generate command signals to displace the components from an initial position to a pre-join position in accordance with a predetermined pre-join position. The iterative method 502 of displacing the first and second components into the pre-join position may be performed in a coordinated manner by the component displacement module 1104 and the position determining module 1102. For example, the position determining module 1102 may provide updated position measurements to the component displacement module 1104 after each displacement, and the component displacement module 1104 may calculate the difference between a current position and a pre-join position and determine if additional displacements are required. The component displacement module 1104 may also be configured to generate command signals to displace the components from the pre-join position to the pre-final position, using the vector displacements. For example, the component displacement module 1104 may receive as input an identification of the components being assembled and retrieve from memory 1002 a set of predefined vector displacements to be applied to bring the components from the pre-join position to the pre-final position. Alternatively, the vector displacements may be input directly into the component displacement module 1104 for application to the components via the assembly tool 904.

The component displacement module 1104 may also be configured to generate command signals to displace the components from the pre-final position to the final position, similarly to the way in which the components are displaced from the initial position to the pre-join position. In some embodiments, the residual spacing between the two components is measured and translational displacements are applied to contact the respective attachment surfaces properly.

The position determining module 1102 and the component displacement module 1104 may be configured in various manners in order to perform the assembly method 200 as described herein. In some embodiments, the assembly controller may be embodied as a computer readable medium having stored thereon program code executable by a processor, the program code comprising instructions for assembling the first component and the second component. The present description is meant to be exemplary only, and one skilled in the relevant arts will recognize that changes may be made to the embodiments described without departing from the scope of the invention disclosed. For example, the blocks and/or operations in the flowcharts and drawings described herein are for purposes of example only. There may be many variations to these blocks and/or operations without departing from the teachings of the present disclosure. For instance, the blocks may be performed in a differing order, or blocks may be added, deleted, or modified.

There is illustrated in FIG. 12 an aircraft assembly 1202 comprising an aircraft wing component 102 having at least one wing attachment surface, the aircraft wing having tolerances referenced with respect to a first datum reference frame, and an aircraft wing box component 104 having tolerances for at least one wing box attachment surface referenced with respect to a second datum reference frame, the first and second datum reference frames derived from sets of datum features on each respective component. The at least one wing box attachment surface is in contact with the at least one wing attachment surface. The assembly 1202 may have been manufactured in accordance with the manufacturing method 300 described above, and assembled in accordance with the assembly method 200 described above. The datum reference frames provided on one or both components 102, 104 may serve as both manufacturing and assembly datum reference frames, and the tolerance margins built into the design may include additional gap clearance for assembling the components together while providing sufficient spacing to avoid clashing.

While illustrated in the block diagrams as groups of discrete components communicating with each other via distinct data signal connections, it will be understood by those skilled in the art that the present embodiments are provided by a combination of hardware and software components, with some components being implemented by a given function or operation of a hardware or software system, and many of the data paths illustrated being implemented by data communication within a computer application or operating system. The structure illustrated is thus provided for efficiency of teaching the present embodiment. The present disclosure may be embodied in other specific forms without departing from the subject matter of the claims. Also, one skilled in the relevant arts will appreciate that while the systems, methods and computer readable mediums disclosed and shown herein may comprise a specific number of elements/components, the systems, methods and computer readable mediums may be modified to include additional or fewer of such elements/components. The present disclosure is also intended to cover and embrace all suitable changes in technology. Modifications which fall within the scope of the present invention will be apparent to those skilled in the art, in light of a review of this disclosure, and such modifications are intended to fall within the appended claims.

1. A method for assembling a wing and a wing box of an aircraft, the method comprising:
providing an aircraft wing component having at least one wing attachment surface, the wing attachment surface having tolerances defined with respect to at least one wing datum feature located in proximity to the wing attachment surface;
providing an aircraft wing box component having at least one wing box attachment surface, the wing box attachment surface having tolerances defined with respect to at least one wing box datum feature located in proximity to the wing box attachment surface; and
assembling the wing component and the wing box component together by superposing the at least one wing datum feature with the at least one wing box datum feature so as to place the at least one wing attachment surface in position to be fastened to the at least one wing box attachment surface.

2. The method of claim 1, wherein a wing datum reference frame is defined by at least three wing datum features and a wing box datum reference frame is defined by at least three wing box datum features, and assembling the wing component and the wing box component comprises superposing the wing datum reference frame and the wing box datum reference frame.

3. The method of claim 2, wherein the at least three wing datum features and the at least three wing box datum features are provided on the wing attachment surface and the wing box attachment surface, respectively.

4. The method of claim 1, wherein when the at least one wing datum feature and the at least one wing box datum feature are superposed, at least a portion of the wing attachment surface is in contact with at least a portion of the wing box attachment surface.

5. The method of claim 1, further comprising referencing the wing component and the wing box component in an assembly reference system using an indoor positioning system.

6. The method of claim 5, wherein referencing the wing component and the wing box component comprises placing at least three targets on each of the wing component and the wing box component, and detecting a position and an orientation in the assembly reference system of each of the wing component and the wing box component using the at least three targets.

7. The method of claim 1, wherein the at least one wing datum feature and the at least one wing box datum feature are physically identifiable on a respective one of the wing component and the wing box component.

8. The method of claim 7, wherein the at least one wing datum feature and the at least one wing box datum feature are holes.

9. The method of claim 1, wherein assembling the wing component and the wing box component comprises:
placing the wing component and the wing box component in a pre-join position, the at least one wing datum feature positioned with respect to the at least one wing box datum feature;
from the pre-join position, moving the wing component and the wing box component into a pre-final position with a gap between the wing attachment surface and the wing box attachment surface; and
from the pre-final position, moving the wing component and the wing box component into a final position by contacting the wing attachment surface and the wing box attachment surface.

10. The method of claim 9, wherein placing the wing component and the wing box component in a pre-join position comprises iteratively displacing at least one of the wing component and the wing box component to reach the pre-join position.

11. The method of claim 9, wherein moving the wing component and the wing box component into a pre-final position comprises applying a sequence of predefined moves to at least one of the wing component and the wing box component to reach the pre-final position.

12. The method of claim 11, wherein applying the sequence of predefined moves comprises applying three vector moves to reach the pre-final position.

13. The method of claim 9, wherein placing the wing component and the wing box component in a pre-join position comprises aligning the at least one wing datum feature and the at least one wing box datum feature with an offset for subsequent displacements.

14. The method of claim 1, wherein providing the wing component and providing the wing box component comprises manufacturing the wing component and manufacturing the wing box component, respectively.

15. The method of claim 14, wherein manufacturing the wing component and manufacturing the wing box component comprises:
designing the wing component and the wing box component in accordance with product features and performance requirements;
providing the at least one wing datum feature on the wing component and the at least one wing box datum feature on the wing box component;
setting manufacturing tolerances for the wing attachment surface with respect to the at least one wing datum feature and setting manufacturing tolerances for the wing box attachment surface with respect to the at least one wing box datum feature; and
manufacturing the wing component and the wing box component in accordance with the manufacturing tolerances as referenced from the at least one wing datum feature and the at least one wing box datum feature, respectively.

16. An aircraft assembly comprising:
an aircraft wing component having at least one wing attachment surface, the at least one wing attachment surface having tolerances defined with respect to at least one wing datum feature located in proximity to the at least one wing attachment surface; and
an aircraft wing box component having at least one wing box attachment surface, the at least one wing box attachment surface having tolerances defined with respect to at least one wing box datum feature located in proximity to the at least one wing box attachment surface, the at least one wing attachment surface and the at least one wing box attachment surface spaced by a gap of between about 0.150 inches and zero inches in a final assembly position prior to being fastened.

17. The assembly of claim 16, wherein the wing component comprises a wing datum reference frame defined by at least three wing datum features and the wing box component comprises a wing box datum reference frame defined by at least three wing box datum features, and wherein the wing datum reference frame is superposed with the wing box datum reference frame.

18. The assembly of claim 17, wherein the at least three wing datum features and the at least three wing box datum features are provided on the wing attachment surface and the wing box attachment surface, respectively.

19. The assembly of claim 16, wherein at least a portion of the wing attachment surface is in contact with at least a portion of the wing box attachment surface.

20. The assembly of claim 16, wherein the at least one wing datum feature and the at least one wing box datum feature are physically identifiable on a respective one of the wing component and the wing box component.

21. The assembly of claim 20, wherein the at least one wing datum feature and the at least one wing box datum feature are holes.

22. The assembly of claim 16, wherein the gap between the at least one wing attachment surface and the at least one wing box attachment surface is filled with a filler material prior to being fastened.

23. The assembly of claim 16, wherein when fastened together, the gap between the at least one wing attachment surface and the at least one wing box attachment surface is closed with negligible deformation of the wing attachment surface and the wing box attachment surface.

24. The assembly of claim 16, wherein the gap is between about 0.100 inches and zero inches.

25. A system for assembling a wing component and a wing box component of an aircraft, the system comprising:
a memory;
a processor coupled to the memory; and
at least one application stored in the memory and having program code executable by the processor for:
determining a relative position of a wing component and a wing box component in an assembly reference frame, the wing component having at least one wing attachment surface, the wing attachment surface having tolerances defined with respect to at least one wing datum feature located in proximity to the wing attachment surface, the wing box component having at least one wing box attachment surface, the wing box attachment surface having tolerances defined with respect to at least one wing box datum feature located in proximity to the wing box attachment surface; and
assembling the wing component and the wing box component together by generating command signals for the at least one wing datum feature with the at least one wing box datum feature so as to place the at least one wing attachment surface in position to be fastened to the at least one wing box attachment surface.
